(19) United States
(12) Patent Application Publication
(10) Pub. No.: US 2014/0077593 A1
(43) Pub. Date: Mar. 20, 2014

(54) BATTERY COMPRISING A CONTROL DEVICE AND METHOD FOR OPERATING SAID BATTERY

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/979,538

(22) PCT Filed: Jan. 9, 2012
(86) PCT No.: PCT/EP2012/000064

§ 371 Date: Nov. 25, 2013

(30) Foreign Application Priority Data
Jan. 13, 2011 (DE) 10 2011 008 466.5

(51) Int. Cl. H02J 1/00

(52) U.S. Cl. CPC H02J 1/00
USPC 307/18

(57) ABSTRACT

The invention relates to a battery (1) comprising: at least one electrochemical energy accumulator device (2, 2a, 2b, 2c) for supplying electrical energy; a control device (3) for monitoring the exchange of energy with the electrochemical energy accumulator device (2, 2a, 2b, 2c); a measuring device (4, 4a, 4b) for recording, at least at times, at least one physical and/or chemical parameter of the electrochemical energy accumulator device (2, 2a, 2b, 2c) and providing an associated measuring value; and a data storage device (5) for recording, at least at times, a value, especially a measuring value

The entire content of priority application DE 10 2011 008 466.5 is hereby incorporated by reference into the present application as an integral part thereof.

The present invention relates to a battery comprising a control device and a method for operating said battery. The invention will be described with reference to a motor vehicle having an electric drive and its supply by a battery according to the invention. The invention can advantageously also be used independent of a motor vehicle drive.

Batteries for supplying motor vehicle drives are known in the prior art. Common to some designs is that they pose a potential risk to their environment due to their inherent energy or its uncontrolled release as a consequence of their chemical components.

The invention is thus based on the object of making it safer to handle batteries.

This object is achieved in accordance with the invention by the teaching of the independent claims. Preferred further developments of the invention constitute the subject matter of the subclaims.

A battery according to the invention comprises one or more electrochemical energy storage devices. They store supplied energy in electrochemical form and release electrical energy as needed. A control device of the battery controls and/or monitors the supply of energy in the provided electrochemical energy storage devices and the withdrawal of energy from said electrochemical energy storage devices. A measuring device of the battery detects one or more physical and/or chemical parameters of one or more electrochemical energy storage devices, at least intermittently, and furnishes the associated measured values. Values, particularly measured values, can be stored in a data storage device and retrieved as needed. The values are preferably stored together with a second value, whereby the second value is representative of the point in time of the measurement. The battery further comprises an output device. Same is provided to at least intermittently output one or more of the values stored in the data storage device.

In the terms of the invention, a battery is to be understood as an apparatus which serves particularly in supplying energy to an electric drive. The battery is thereby provided with connection terminals and a housing and, in preferred embodiments, so comprehensively designed that only a few further electrical connections need to be made to the respective engine, system or motor vehicle to supply the drive. In accordance with one preferential embodiment, the battery comprises mechanical connecting means which are in particular provided for quickly replacing the entire battery.

In the terms of the invention, an electrochemical energy storage device is to be understood as a device which in particular serves in storing supplied energy and releasing electrical energy to a drive or load as needed. To store the electrical energy supplied, same is converted before-hand into chemical energy. The conversion of the energy ensues in the reverse direction when being withdrawn. The battery preferably comprises a plurality of electrochemical energy storage devices. Said plurality of electrochemical energy storage devices are electrically interconnected. One preferential embodiment of the inventive battery comprises a plurality of electrochemical energy storage device groups, wherein the electrochemical cells of one group are connected in series. Preferably, a plurality of groups are connected in series to in particular attain higher voltage and/or a plurality of groups are connected in parallel to in particular attain higher charging capacity.

In the terms of the invention, a control device is to be understood as a device which in particular controls and monitors the operating and the non-operative state of the battery's electrochemical energy storage device. The control device further serves particularly in the processing of measured values, requesting one or more measured values from the measuring device as needed, saving values to the data storage device, reading values from the data storage device and/or particularly in communicating with a higher-order controller of an engine, system or motor vehicle.

In accordance with one preferential embodiment, the control device controls the supply and withdrawal (exchange) of energy from at least one of the electrochemical energy storage devices in consideration of particularly its temperature, state of charge and/or load need.

The control device thus in particular counteracts different states of charge and/or excessive loads of individual electrochemical energy storage devices.

In the terms of the invention, a measuring device is to be understood as a device which in particular serves in detecting physical and/or chemical parameters of one or more of the battery's electrochemical energy storage devices. As a result, the measuring device provides one or more associated measured values. Same are processed by the control device, stored in a data storage device and/or output by an output device. The measuring device comprises at least one sensor for measuring. The measuring device preferably comprises one sensor per each electrochemical energy storage device. The measuring device preferably comprises sensors for different physical and/or chemical parameters. The measuring device preferably compresses the measured values of its sensors by means of in particular low-pass filters and/or generates temporal mean values for the detected measured values. In accordance with one preferential embodiment, the measuring device in particular also successively samples its sensors periodically without being prompted by the control device, thereby advantageously saving the control device's computing time.

In the terms of the invention, a physical and/or chemical parameter refers to a parameter which in particular serves in registering the status of an electrochemical energy storage device. Here, these are in particular electrical variables such as electric voltage, electric current, electric charge, internal resistance, electrochemical energy storage device deep discharge and short-circuit current. Temperature, particularly higher than 130° C., in particular the surface tempera-ture, electrochemical energy storage device internal pressure, moisture, corrosion and deterioration are also to be considered as advantageous physical and/or chemical parameters.

In the terms of the invention, a data storage device is to be understood as a device which serves in the storing of particularly individual values, value pairs, measured value histories, target values, target histories, control device operating software progress messages, error messages and also evaluated variables and states. The values, histories, evaluations, etc. stored in the data storage device can be read by the control device and/or output by the output device, particularly to a higher-order controller and/or an external unit or device which is not part of the battery. The data storage device is preferably designed as a non-volatile memory element. The data advantageously remains stored in the data storage device even after a power supply outage.

In the terms of the invention, an output device is to be understood as a device which in parti-cular serves in outputting a value stored in the data storage device, preferably to a higher-order controller and/or to an external unit or device not associated with the battery. According to one preferential embodiment, the output device comprises at least one visible and/or audible output means thereto, such as one or more light-emitting diodes, beepers and/or segment displays in particular. Another preferential embodiment of the output device comprises contacts for connecting to an external device or unit which is in particular only intermittently connected to the output device. According to a further preferential embodiment, the output device functions interactively so that particularly individual values stored in the data storage device are also selectively accessible via the external unit. The output device preferably outputs values, in particular periodically, which provide information on an electrochemical energy storage device's state of charge, particularly its internal resistance, its open-circuit voltage, its temperature, its internal pressure, a measured value from one of the measuring device's sensors, a control device operating software progress message, an error message and/or a warning message. The viewer is thereby given advantageous information and/or statuses or warnings or messages as concerns fault-free operating state. The viewer can advantageously visually identify a safety-scaled battery status all the way through to defective battery.

With a battery designed in accordance with the invention, a person receives an impression of the operational status of the battery or one of its electrochemical energy storage devices respectively. By means of the output device, even without taking his own measurements or examining the battery, the person advantageously realizes in particular unwanted and/or hazardous operational states of the battery or one of its electrochemical energy storage devices respectively. With knowledge of the battery status, the person can take measures for his own protection or measures to protect the environment, particularly prior to changing the battery, transporting the battery separately from a motor vehicle, when salvaging a vehicle damaged in an accident and/or when salvaging the battery, particularly from a vehicle damaged in an accident. Thus, the inventive battery contributes to reducing the potential threat to living organisms and the environment by the output device providing information on the degree of potential hazard, hence achieving the underlying object.

The following will describe preferential further developments of the invention.

In accordance with one preferred embodiment, the battery comprises one or more electro-chemical energy storage devices, each having an electrode stack. An electrode stack groups together at least one succession of anode plate, separator plate and cathode plate. Said plates are preferably of substantially rectangular configuration. The electrode assembly is in particular positively encased in an enclosure. The enclosure is preferably designed as a metallic composite film or at least in part as a metallic, particularly deep-drawn, molded part.

In accordance with a further preferred embodiment, the electrode assembly is configured as an electrode coil having at least one succession of anode strip, separator strip and cathode strip. Said electrode coil exhibits a substantially cylindrical shape. The electrode assembly is preferably designed as a flat-wound electrode. The shape of the flat-wound electrode is then more rectangular than cylindrical. The electrode assembly is in particular positively encased by the enclosure. The enclosure is preferably designed as a metallic composite film or at least in part as a metallic, particularly deep-drawn, molded part.

In accordance with one preferred embodiment, the electrode assembly comprises lithium ions. As active material, the electrode assembly preferably comprises a lithium metal phosphate (LiMPO₄), particularly preferentially lithium iron phosphate. In accordance with a further preferred embodiment, the electrode assembly comprises a mixture of a non-spinel structure lithium/nickel/manganese/cobalt mixed oxide (NMC) and a lithium/manganese oxide (LMO) in a spinel structure as the active material.

In accordance with one preferred embodiment, the electrode assembly comprises a separator which does not conduct or only poorly conducts electrons and which consists of an at least partially material-permeable substrate. The substrate is preferably coated on at least one side with an inorganic material. An organic material which is preferably developed as a non-woven fabric is preferably used as the at least partially material-permeable substrate. The organic material, which preferably comprises a polymer and particularly preferentially a polyethylene terephthalate (PET), is coated with an inorganic, preferably ion-conducting material which further preferably conducts ions in a temperature range of −40° C. to 200° C. The inorganic material preferably comprises at least one compound from the group of oxides, phosphates, sulfates, titanates, silicates, aluminosilicates of at least one of the elements Zr, Al, Li, particularly preferably zirconium oxide. Said inorganic, ion-conducting material preferably comprises particles having a maximum diameter of less than 100 nm. Such a separator is sold for example in Germany by Evonik AG under the trade name of “Separion.”

In accordance with one preferred embodiment, the measuring device of the battery comprises an acceleration sensor. The acceleration sensor serves in particular to detect excessive acceleration and/or impacts affecting the battery or its electrochemical energy storage devices. The acceleration sensor thus advantageously enables detecting a battery drop or accident or a collision of the battery with a foreign object. An acceleration being measured above a predefined, particularly design-contingent threshold, suggesting an indication of possible disturbance to the function or safety of the battery, is advantageously stored and output. An acceleration time integral is preferably generated and evaluated, particularly by the control device, to detect an impact or accident.

In accordance with one preferred embodiment, the measuring device comprises one or more predetermined breaking devices as a sensor. Said at least one predetermined breaking device is preferably arranged in the battery's external region, particularly preferentially on an external periphery of the battery. The predetermined breaking device is preferably provided to conduct an electrical current or emit a voltage respectively as a signal in a first operational state. After breaking and in the second operational state, the predetermined breaking device no longer emits any signal. The absence of the predetermined breaking device's signal is advantageously stored and output as an indication of a possible disturbance to the battery's function or safety.

In accordance with one preferred embodiment, the battery exhibits at least two operational states. In a first operational state, at least the control device, and preferably also the measuring device, data storage device and/or output device, are supplied with energy by one or more of the battery's electrochemical energy storage devices. In a second operational state, the battery's electrochemical energy storage devices are incapable of electrically supplying the control device, data storage device, measuring device and/or output device. This is particularly the case when one or more electrochemical energy storage devices has an insufficient charge, is damaged and/or is disconnected and/or isolated from the control device. The content of the data storage device is particularly informative in identifying the cause of the second operational state. A person can advantageously use the output device to access the content of the data storage device and/or review the memory content to determine the battery's operational state and/or to determine a dysfunction, particularly during the battery's second operational state.

In accordance with one preferential embodiment, the battery comprises an electrical energy storage unit. Same serves in particular to at least intermittently supply the control device, the data storage device, measuring device and/or the output device with energy, particularly during the second operational state. The electrical energy storage unit is preferably designed as a secondary battery. The electrical energy storage unit is preferably charged at least inter-mittently by at least one of the battery's electrochemical energy storage devices. The electrical energy storage unit is advantageously designed to at least intermittently supply the control device, measuring device, data storage device and/or output device, particularly when one or more of the electrochemical energy storage devices falls below a predefined threshold voltage.

In accordance with one preferred embodiment, external energy is supplied to at least the output device and the data storage device via the output device contacts, particularly when the elec-trical energy storage unit is discharged. At least one value can also be advantageously queried and output from the data storage device upon insufficiently charged energy storage unit.

In accordance with one preferential embodiment, the output device of the battery comprises a wireless communication device. Said wireless communication device is preferably designed as a transponder, particularly preferentially as an RFID device. In this embodiment, the battery's state can advantageously be determined without contact. With knowledge of the battery's hazard potential, a person can take the appropriate safety precautions. In accordance with one preferential embodiment, the wireless communication device advantageously supplies the display device and data storage device with energy during the battery's second operational state.

In accordance with one preferential embodiment, the battery comprises a position determination device. Same serves in particular to transmit an indication of the battery's position. The position information is preferably conveyed by radio or GSM. The position information is preferably sent particularly at predetermined times, in particular periodically. Doing so thus advantageously limits the position determination device's energy consumption. An identification is preferably sent with the position information which is in particular indicative of the battery's model and/or serial number.

The following will describe different methods of operating the battery.

In accordance with one preferred first method of operating the battery according to the invention (first operating method), the measuring device detects at least one physical and/or chemical parameter of at least one electrochemical energy storage device (step S1), particularly preferably different successive physical and/or chemical parameters of a plurality of electro-chemical energy storage devices. The measured values are preferably compressed by filtering and/or by the measuring device generating in particular temporal mean values. The measuring device furnishes the measured values particularly via a signal bus (step S2) for processing by the control device and/or saving in the data storage device (step S3). It is particularly preferen-tial to store a measured value together with a second value, wherein the second value is representative of the time the measurement was taken. By so doing, a log of the battery's operational data is advantageously created in the data storage device.

In a preferential form of the first operating method, in particular following S2, the control device in particular determines the operational status of at least one of the electrochemical energy storage devices, particularly by differential generation and/or quotient calculation of detected measured values and one of the associated target values for said physical and/or chemical parameter stored in the data storage device (step S4). The logic result is also saved (step S6). Contingent upon the logic result, the control device returns a specific operational state as a result (step S7). A differentiation is thereby made at least between the first operational state of the battery and its second operational state. Should in particular the measured and evaluated terminal voltage of one or more electrochemical energy storage devices lie outside of a predefined range (desired battery voltage), the control device returns the presence of the second operational state as a result (step S5). The second operational state is thereby preferably divided at least into:
insufficient state of charge of at least one of the electrochemical energy storage devices (operational state 2a),
defect in one of more of the electrochemical energy storage devices (operational state 2b), and
one or more disconnected electrochemical energy storage devices (operational state 2c).

Particularly applicable to an unwanted operational state 2b or 2c are temperature gradients over time and/or temperature gradients along a segment of the battery, excessive tempera-ture, overvoltage, too high of an electric current, exceeding an indicative threshold as a condition signifying the presence of the operational state. Excessive stress during transport prior to placing the battery into operation and after evaluating particularly temperature, pressure, moisture, maximum acceleration value, acceleration time integral, control segment internal resistance of a cell short circuit and/or radiation intensity is advantageously detected. A combination of detected voltage drop and temperature increase compared to the values stored in the data storage device is particularly indicative of operational state 2b.

Operational state 2c is in particularly present when a measured value for an electrochemical energy storage device falls outside of a predefined range, whereby damage to the relevant electrochemical energy storage device cannot, however, be assumed yet. A temperature of an electrochemical energy storage device which is higher than a predefined maximum temperature and/or an internal pressure which is higher than a predefined maximum pressure are advanta-geously conditions indicating the presence of operational state 2c. In operational state 2c, the control device advantageously no longer allows the further exchange of electrical energy with the relevant electrochemical energy storage device, particularly for safety reasons.

In one preferential embodiment, a battery according to the invention comprises groups of interconnected cells. Said battery groups are monitored individually. Status is also evaluated and analyzed in groups. The observer is thus advantageously informed as to which specific cell group originated the hazard. The hazardous cell group can advantageously be removed and/or exchanged prior to transporting.

Following at least one of the steps S2 to S6, the output device outputs a value stored in the data storage device (step S7). The value, or stored information respectively, output is thereby preferentially a value indicating to a person a particularly unwanted battery operational state. The value or the operational state respectively is preferentially analogously output as one of the following classifications:
“healthy” for the first operational state,
“faulty” for operational state 2a,
“unsafe” for operational state 2b or 2c.

It is particularly preferential for the output to take the form of differently-colored light-emitting diodes, particularly with the colors of green for “healthy,” yellow for “faulty” and red for “unsafe.”

In a further preferential form of the first operating method, at least one signal of an acceleration sensor and/or a predetermined breaking device is evaluated to determine the presence of the second operational state. When their measured values are outside of predetermined ranges, the presence of the second operational state can thus be assumed, particularly operational state 2b (step S8). It is advantageously indicated to a person seeking information about the operational state of the battery that battery damage is possible due particularly to a drop and/or accident.

In accordance with a second preferred method of operating a battery according to the invention (second operating method), the electrical energy storage unit at least intermittently supplies electrical energy to the control device, data storage device, output device and/or measuring device (step S9), particularly during the battery's second operational state (emergency power supply). In so doing, the supply and functioning of the control device, data storage device, output device and/or measuring device is advantageously ensured, in particular also during an outage of one or more of the battery's electrochemical energy storage devices. In the case of an outage or insufficiently charged electrochemical energy storage devices of the battery, the output device is capable of displaying values and/or operational states from the data storage device due to the supply from the electrical energy storage unit (step S10). When supplied by the electrical energy storage unit, the output device preferably only outputs data storage device content at predetermined times.

In one preferential form of the second operating method, the output device is prompted to output by means of external query, particularly by a query from an external unit which is not part of the battery. This thus advantageously limits the energy consumption of the output device.

In one preferential form of the second operating method, the query by an external device not associated with the battery triggers in particular a predefined sequence of method steps. Doing so serves in particular to determine the battery's hazard potential based on the most current measured values possible. Steps S1-S2-S4, S1-S2-S5 or S1-S2-S8 are preferably implemented (step S11) upon query by an external device unassociated with the battery. The external query advantageously triggers a first battery self-check.

In a further preferential form of the second operating method, the output device transitions from a non-operative state, particularly during the second operational state to, upon supply by the electrical energy storage unit, an activated state. Such activation is triggered by a query from an external device which is not a part of the battery (step S12). Doing so thus advantageously limits the output device's energy consumption. In a preferential form of the second operating method, S11 follows after S12.

In one preferential form of the first and/or second operating method, the output device repeats the output of the same value(s), particularly with a predefined time interval between the two outputs. The predefined time interval preferably increases with decreasing residual charge of the battery's electrochemical energy storage devices or with decreasing residual charge of the electrical energy storage unit particularly during the battery's second operational state respectively. In particular, the time interval of up to 10 s indicates nearly full charge, the time interval of up to 50 s indicates 50% residual charge, the time interval of up to 100 s indicates 10% residual charge, the time interval of up to 1000 s indicates 1% residual charge. It is particularly preferential for this output as well to be by means of the repeated flashing of at least one light-emitting diode, particularly with one of the colors of green for the “healthy” state, yellow for “faulty” and red for “unsafe.” A person is thus advantageously informed simultaneously about the battery state and the residual charge.

In accordance with a preferential third operating method, the position determination device receives at least one, preferably three or more positioning signals (step S13), particularly from satellites. The position determination device processes the received positioning signals into position information (step S14). The position determination device further forwards the position information (step S15). The position infor-mation is preferably only forwarded at predefined times, in particular periodically. Doing so thus advantageously limits the position determination device's energy consumption.

In one preferred form of the third operating method, the position determination device repeats transmission, particularly with a predefined time interval between transmissions. The predefined time interval preferably increases with decreasing residual charge of the battery's electrochemical energy storage devices or with decreasing residual charge of the electrical energy storage unit particularly during the battery's second operational state respectively. In particular, the time interval of up to 100 s indicates nearly full charge, the time interval of up to 500 s indicates 50% residual charge, the time interval of 1000 s indicates 10% residual charge, the time interval of up to 10,000 s indicates 1% residual charge. A person located at a distance from the battery is thus advantageously informed about the battery's location and residual charge.

In one preferred form of the third operating method, the position determination device sends information with the position information which indicates the battery's operational state. Thus, a person located at a distance from the battery is advantageously informed about the battery's location and operational state.

According to one preferred embodiment, the battery is designed to operate in accordance with the first and second operating methods. A battery of such design can preferably also be operated in accordance with the operating method.

Further advantages, features and possible applications of the present invention will follow from the following description in conjunction with the figures. Shown are:

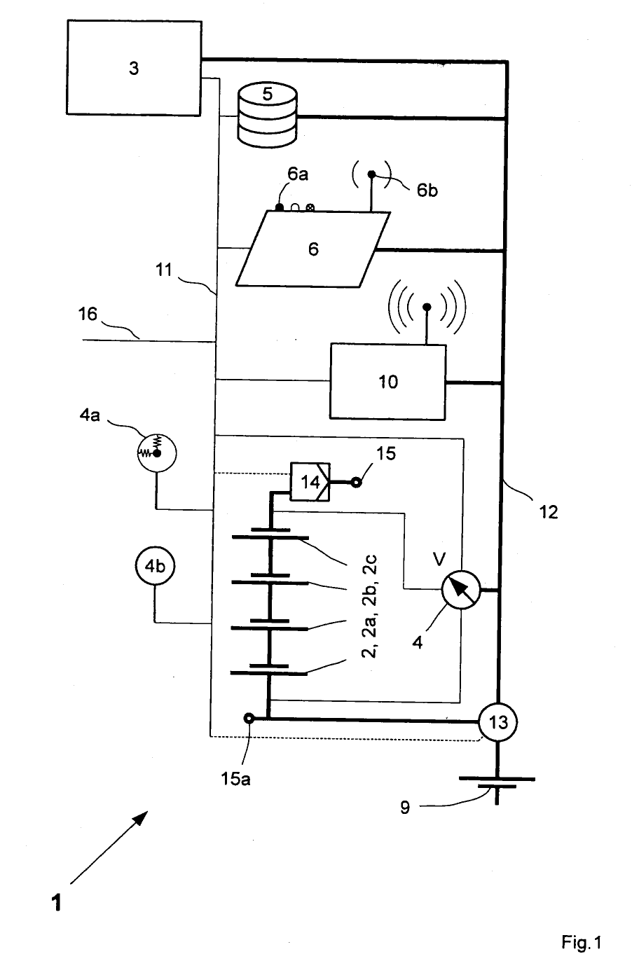

FIG. 1 a preferential embodiment of a battery according to the invention,

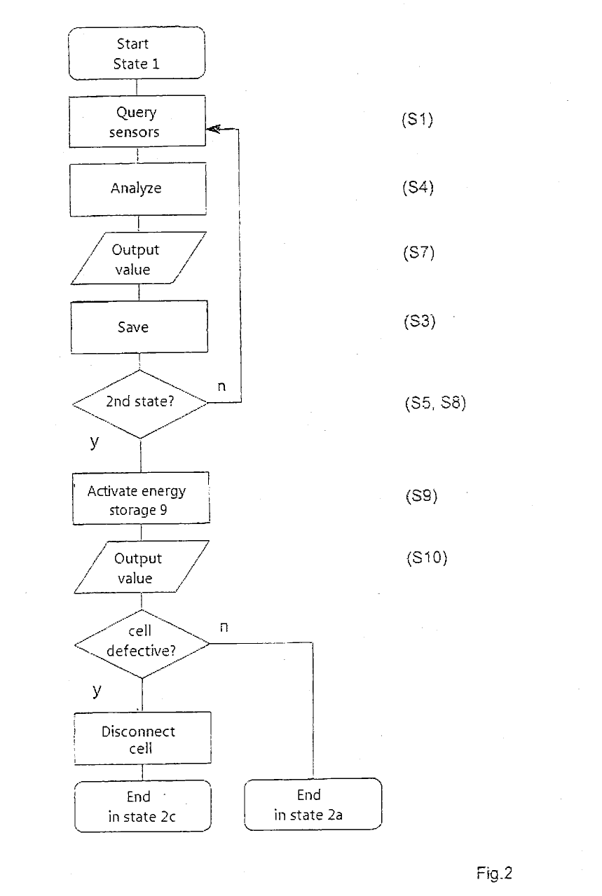

FIG. 2 a flow chart of a preferential operating method for an inventive battery, and

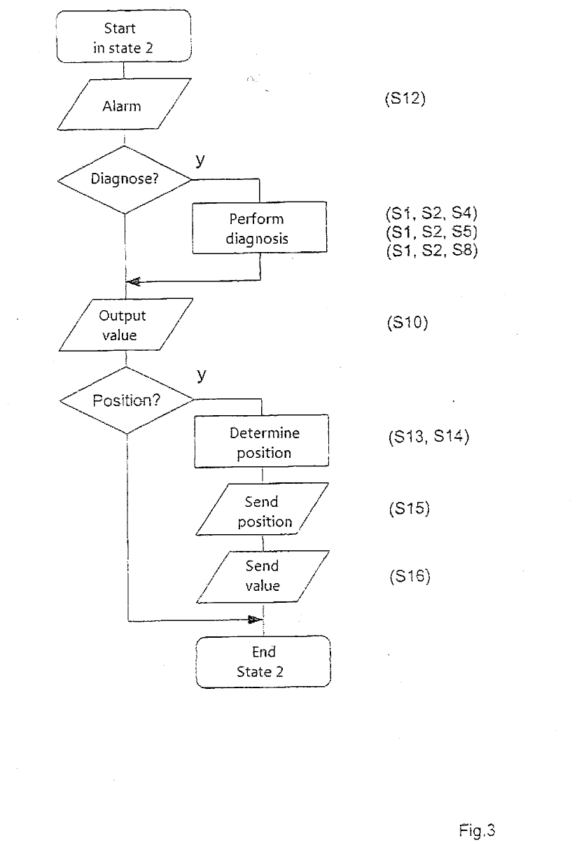

FIG. 3 a further preferential operating method for a battery according to the invention.

FIG. 1 shows an inventive battery 1 in accordance with one preferential embodiment. The battery 1 comprises electrochemical energy storage devices 2, 2a, 2b, 2c connected in series with connection terminals 15, 15a for connecting to an electrical load, particularly to the electric drive of a motor vehicle. The battery 1 comprises a control device 3, a measuring device 4, configured here as a voltmeter, a data storage device 5 as well as an output device 6. The battery further comprises a position determination device 10 as well as an electrical energy storage unit 9.

The measuring device 4 having at least one multiplexer, buffer, filter and diverse sensors for electric current, voltage, temperature and pressure is not fully depicted. The multiplexer successively measures physical and/or chemical parameters of the electrochemical energy storage devices 2, 2a, 2b, 2c. So that the data storage device 5 will not be flooded with an abundance of data, which would not facilitate analyzing malfunctions of the battery 1, the measured values detected are averaged over time. The measuring device 4 advantageously provides data packets instead of individual values.

The data bus 11 connects the control device 3, the data storage device 5, the output device 6, the measuring device 4 as well as the position determination device 10. Control leads depicted with dotted lines to the drive control system 14 as well as to the switching unit 13 also run from data bus 11. The series connection of the electrochemical energy storage devices 2, 2a, 2b, 2c, the electrical energy storage unit 9 and the power bus 12 are connected to switching unit 13. The control device 3, the data storage device 5, the output device 6, the measuring device 4 as well as the position determination device 10 are connected to their power supplies on the power bus 12. The switching unit 13 has different switch positions and in particular enables the supplying of the control device 3, data storage device 5, output device 6, measuring device 4 and position determination device 10 via the series connection of the electrochemical energy storage devices 2, 2a, 2b, 2c or via the electrical energy storage unit 9. The switching unit 13 can be further switched such that the electrochemical energy storage devices 2, 2a, 2b, 2c advantageously charge the electrical energy storage unit 9.

A connecting line 16 to a not-shown external device which is not a part of the battery is further connected to the data bus 11. The connecting line 16 enables the output device 6 to be switched from its non-operative state into its activated state. Data can also be read from the data storage device 6 by means of connecting line 16.

The acceleration sensor 4a as well as the predetermined breaking device 4b are further connected to the data bus 11. The predetermined breaking device 4b is mounted on the battery's outer skin. The data storage device 5 is designed as a non-volatile memory element. The output device 6 comprises a communication device 6b for the wireless communication with an external device which is not a part of the battery. Said communication device 6b can advantageously send values from the data storage device 5 to an external device wirelessly. Data storage device 5 and output device 6 are advantageously powered wirelessly.

The battery 1 as depicted can be operated in accordance with the first operating method, a preferential form of which is depicted in FIG. 2. In the process, the measuring device 4 first detects the physical and/or chemical parameter of the given electrochemical energy storage devices 2, 2a, 2b, 2c (S1). The measured values are stored in the data storage device 5 (S3). In an advantageous enhancement to the first operating method, the measured values and/or the logical results of the control device 3 on the operating state of battery 1 are evaluated (S4) and stored (S6). Given the respective predetermined conditions, the battery operating state is recognized as the second operating state (S5, S8). When the second operating state is given, energy storage unit 9 is activated (S9). That advantageously occurs, as FIG. 1 depicts, by means of the switching unit 13. In one preferential form, the activating of the energy storage unit 9 ensues by means of a not-shown passive switch. Said passive switch gives the supply by the electrochemical energy storage units 2, 2a, 2b, 2c priority over the supply by the electrical energy storage unit 9 as long as the series connection of the electrochemical energy device 2, 2a, 2b, 2c exceeds a minimum voltage, here 5V. Otherwise, the energy storage unit 9 also assumes the supply of the output device 6. After activation of the energy storage unit 9, the output device 6 displays the changed operating state at least by means of one of the diodes 6a (S10). In the event that one of the electrochemical energy storage devices or cells appear damaged, same is then deactivated.

The battery depicted in FIG. 1 can also be operated according to a second operating method. The output device 6 in non-operative state is activated by means of an alarm (S12). If preset or required, steps S1 and S2 will first be implemented. An evaluation in accordance with steps S4, S5 and/or S8 follows. The recently determined values or older values are output (S10). Thus, one seeking information discovers in which state the battery is in and can take the appropriate measures.

The battery depicted in FIG. 1 can also be operated according to a third operating method. This method is depicted in the lower part of FIG. 2. If preset, the position determination device 10 determines the position of the battery 1 particularly at predetermined time points or by request (S12, S13). The position information is subsequently forwarded (S15). If preset or required, queried or set values will be sent with the position information (S16). Thus, one seeking information advantageously learns the state of the battery even without being in its immediate vicinity.

1. A battery comprising:
at least one electrochemical energy storage device provided to release electrical energy;
one control device provided to monitor exchange of energy with the electrochemical energy storage device;
one measuring device provided to at least intermittently detect one or more physical and/or chemical parameters of the electrochemical energy storage device and to furnish an associated measured value;
one data storage device provided to be at least intermittently written with a measured value, wherein the measured value, can be saved in the data storage device and retrieved when needed;
one output device provided to at least intermittently output at least one value stored in the data storage device, wherein
in a first operational state, the control device is supplied by at least one electrochemical energy storage device,
in a second operational state, the control device is not supplied by any electrochemical energy storage device,
the battery further including an electrical energy storage unit provided to at least intermittently supply the control device, the data storage device, the measuring device and/or the output device with energy in the second operation state.

2. The battery according to claim 1, wherein
the at least one electrochemical energy storage device comprises an electrode assembly, which stores electrical energy, and a housing which at least partly encloses the electrode assembly, wherein the housing comprises at least one metallic material,
the electrode assembly comprises lithium, and
the electrode assembly comprises at least one separator, wherein the separator does not conduct electrons and includes an at least partially material-permeable substrate, wherein the substrate is coated on at least one side with an inorganic material, wherein an organic material is used as the at least partially material-permeable substrate which is developed as a non-woven fabric, wherein the organic material comprises a polymer, wherein the organic material is coated with an inorganic, ion-conducting material which conducts ions in a temperature range of −40° C. to 200° C., wherein the inorganic material comprises at least one compound from the group of oxides, phosphates, sulfates, titanates, silicates, aluminosilicates of at least one of the elements Zr, Al, Li, zirconium oxide, and wherein the inorganic, ion-conducting material comprises particles having a maximum diameter of less than 100 nm.

3. The battery according to claim 1, wherein
the measuring device comprises an acceleration sensor and/or a predetermined breaking device.

4. (canceled)

5. The battery according claim 1, wherein
the output device comprises a wireless communication device, wherein the communication device is provided to at least intermittently output a measured value stored in the data storage device and/or predefined information, wherein the predefined information is indicative of the operational state of at least one of the electrochemical energy storage devices.

6. The battery according to claim 1, wherein a position determination device is provided to receive at least one positioning signal, to process the at least one positioning signal into position information, and to forward said position information.

7. A method for operating a battery in accordance with claim 1, comprising:
detecting at least one physical and/or chemical parameter of an electrochemical energy storage device by the measuring device;
furnishing a measured value corresponding to the measured physical and/or chemical parameter by the measuring device; and
storing the measured value to the data storage device by the control device.

8. The method according to claim 7, wherein target values for the physical and/or chemical parameters and predefined logic results are stored in the data storage device, and the method further includes:
determining an operational state of at least one of the electrochemical energy storage devices by the control device from at least one measured value by association with a target value stored in the data storage device;
determining the presence of a second operational state when the measured value logic result of measured value corresponding to measured voltage of one of the at least one electrochemical energy storage devices, and target value corresponds to a predefined result;
saving the result of the associated measured value and target value in the data storage device together with a second value which is representative of a time point of the measurement and/or the determination;
outputting a value stored in the data storage device by the output device corresponding to an operational state, a measured value and/or a logic result, upon query from an external device which is not part of the battery.

9. The method according to claim 7, wherein the measuring device comprises an acceleration sensor and/or a predetermined breaking device, the method further comprising:
determining a presence of the second operational state when the logic result of measured value of the acceleration sensor and/or query of the predetermined breaking device with an associated target value corresponds to a predefined result.

10. The method of operating a battery according to claim 7, wherein
the electrical energy storage unit at least intermittently supplies electrical energy to the control device, the data storage device, the output device and/or the measuring device during the second operational state.

11. The method according to claim 10, wherein
the output device outputs a value stored in the data storage device corresponding to an operational state, a measured value and/or a logic result, upon query by an external device which is not a part of the battery.

12. The method according to claim 10, wherein
at least one of the method steps is performed upon query by an external device which is not a part of the battery.

13. The method according to claim 10, wherein the output device is initially in a non-operative state during the second operational state, and
the output device is converted from the non-operative state into an activated state following a query by an external device which is not a part of the battery.

14. The method according to claim 7, wherein
the position determination device at least intermittently receives one or more position determination signals,
the position determination device processes the received position determination signals into position information,
the position determination device forwards said position information as a function of an operational state, a measured value and/or a logic result, and
the electrical energy storage unit supplies energy to the position determination device during the second operational state.

15. The method according to claim 14, wherein
the position determination device sends at least one operational state, one measured value and/or one logic result with the position information during the second operational state.

16. Am method for operating a battery according to claim 7, wherein
the electrical energy storage unit at least intermittently supplies electrical energy to the control device, the data storage device, the output device and/or the measuring device during the operational state,
the output device outputs a value stored in the data storage device corresponding to an operational state, a measured value and/or a logic result, upon query by an external device which is not part of the battery,
the output device is prompted to output via an external query from an external device which is not part of the battery,
upon query by the external device which is not part of the battery, at least one of the method steps is performed,
the output device is converted from the non-operative state into an active state following the query by the external device which is not part of the battery, and
the output device repeats the output of a same value at a predefined time interval between two successive outputs, wherein the predefined time interval increases with decreasing residual charge of the at least one electrochemical energy storage device or with decreasing residual charge of the electrical energy storage unit respectively, during the second operational state of the battery.

17. The battery according to claim 1, wherein in the second operational state, the one or more electrochemical storage devices have an insufficient charge, are damaged and/or are disconnected or isolated from the control device,
the electrical energy storage unit is at least intermittently charged by at least one of the at least one electrochemical energy storage devices of the battery,
at least one output device and data storage device are supplied with external energy via the contacts of the output device, when the electrical energy storage unit is discharged, and
the output device outputs values periodically which provide information on a state of charge of an electrochemical energy storage device, an internal resistance thereof, an open circuit voltage thereof, a temperature thereof, an internal pressure thereof, a measured value from a sensor of the measuring device, a control device operating software progress message, and error message and/or a warning message.

18. The battery according to claim 1, wherein the measured value is saved in the data storage device together with a second value representative of a point in time of the measurement.

19. The method according to claim 7, wherein the measured value is stored in the data storage device together with a second value representative of a point in time of the measurement.
